(19) United States
(12) Patent Application Publication
(10) Pub. No.: US 2003/0079633 A1
(43) Pub. Date: May 1, 2003

(54) Printer roller identification

(76) Inventor: Henry W. Sang JR., Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/984,150

(22) Filed: Oct. 29, 2001

(51) Int. Cl. B41F 13/10

(52) U.S. Cl. 101/375

(57) ABSTRACT

A printer system including one or more printer rollers is capable of imprinting an identifiable texturing on print media. The identifiable texturing can be used to match print media from the printer system with the printer system. The printer system can imprint identifiable texturing that is not visible to the unaided eye. Therefore, a user of the printer system is unaware that the print medium can be matched with the printer system. The imprinting process is a relatively simple process in which the surface of the print medium is mechanically deformed. Therefore, expensive chemical analysis is not required to match the print medium with the printer system.

### TECHNICAL FIELD

The technical field is printer systems, particularly printer systems capable of imprinting identifiable texturing on print media.

### BACKGROUND

In order to enforce laws against counterfeiting operations, law enforcement agencies gather facts and evidence linking suspected counterfeiters to a counterfeiting crime. One form of evidence is to show that counterfeit print samples were created by printer systems belonging to the suspected counterfeiters. Law enforcement agencies use several methods to match counterfeit print samples of unknown origin with printer systems.

One method of matching a print sample of unknown origin with a printer system involves deliberately modifying printer systems so that print samples contain a unique “fingerprint” of the printer system. For example, a printer system may imprint its fingerprint on a print sample by marking the print sample with a very light color. However, counterfeiters may avoid using a printer system having such a marking system because the light color marking may be detectable by the unaided eye.

Chemical identification, or “chemical fingerprinting,” may also be used to match a print sample with a printer system. In chemical fingerprinting, chemicals of the ink contained in a print cartridge have a unique composition that is not detectable by the unaided eye. A counterfeit print sample can therefore be matched with a suspected printer system by comparing the ink on the print sample with the ink in the print cartridge used by the printer system. Chemical fingerprinting may be impractical, however, because of the high cost and complexity involved in the mass production of print cartridges with unique compositions of ink. Depending on the process used, the chemical analysis required to match a counterfeit print sample to a print cartridge may also be expensive. Additionally, chemical fingerprinting may be ineffective because counterfeiters would most likely use the print cartridges very quickly and discard them soon after use.

Therefore, a need exists for a reliable and effective system and method for matching print media with a printer system that does not involve excessive cost or complexity.

### SUMMARY

According to a first aspect, a printer system can include one or more patterned printer rollers capable of imprinting an identifiable texturing on print media. The identifiable texturing can be used to match print media from the printer system with the printer system.

According to the first aspect, the printer system can generate identifiable texturing that is not visible to the unaided eye. Therefore, a user of the printer system is unaware that a print medium can be matched with the printer system.

Also according to the first aspect, the imprinting process is a relatively simple process in which the surface of a print medium is mechanically deformed. Therefore, expensive chemical analysis is not required to match the print medium with the printer system.

Other aspects and advantages will become apparent from the following detailed description, taken in conjunction with the accompanying figures.

### DESCRIPTION OF THE DRAWINGS

The detailed description will refer to the following drawings, wherein like numerals refer to like elements, and wherein:

FIG. 1 is a cross-sectional view of a printer system according to a first embodiment;

FIG. 2A is a side view of a patterned printer roller having a patterned surface according to the first embodiment;

FIG. 2B is a cross-sectional view of the patterned printer roller of FIG. 2A taken on line 2B-2B;

FIGS. 2C-2G illustrate various patterns that may be formed in the patterned printer roller;

FIG. 3 is a flow chart illustrating a method for imprinting an identifiable texturing on a print medium using a printer system having one or more patterned printer rollers;

FIG. 4 is a flow chart illustrating a method for making a patterned printer roller using an impression mold process;

FIGS. 5A-5F illustrate a method for making the patterned printer roller according to the method illustrated in FIG. 4;

FIG. 6 is a flow chart illustrating a method for making a patterned printer roller using a sandblasting process; and

FIGS. 7A-7C illustrate a method for making the patterned printer roller according to the method illustrated in FIG. 6.

### DETAILED DESCRIPTION

A printer system and method for imprinting identifiable texturing on print media will be discussed by way of preferred embodiments and by way of the figures.

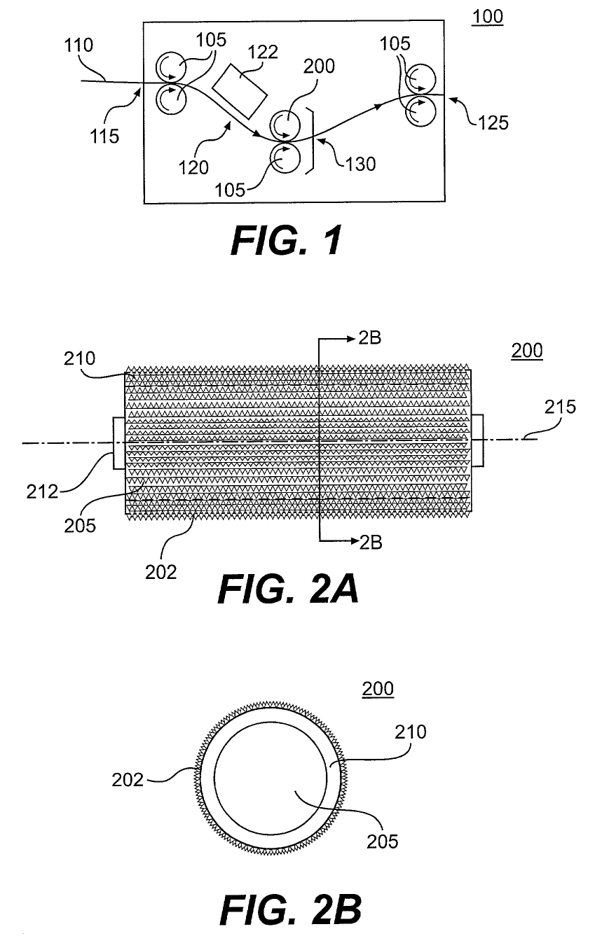

FIG. 1 illustrates a cross-sectional view of a printer system 100 having several printer rollers 105. The printer system 100 also includes at least one patterned printer roller 200 having a patterned surface. The patterned printer roller 200 is used to imprint identifiable texturing on print media. The identifiable texturing can be used to match print media with the printer system 100. The print media may be, for example, paper, cardboard, transparent film, fabric, laminated sheets, label stock and other types of printable media. The operation of the printer system 100 is discussed in detail below.

In the printer system 100, the printer rollers 105 may be, for example, conventional pinch rollers such as those used in conventional printer systems. The printer system 100 includes an entry 115, a feed path 120, a toner system 122 and an exit 125. Print media 110 are loaded into the printer system 100 at the entry 115, advanced along the feed path 120 by the printer rollers 105, printed upon by toner system 122 and ejected at the exit 125. The orientation of the feed path 120 inside the printer system 100 may be defined by the position of various additional internal components (not shown) of the printer system 100. The printer system 100 may include one or more printer roller pairs 130 of opposed printer rollers 105. Additionally, the printer system 100 may include a printer roller pair 130 that includes one or two opposed patterned printer rollers 200. The printer rollers in each printer roller pair 130 are capable of rotating in unison with respect to each other. A printer roller pair 130 having one or two patterned printer rollers 200 may be located at one of various points along the feed path 120, including, for example, near the entry 115 or the exit 125 of the printer system 100 or a location immediately before or after the toner system 122.

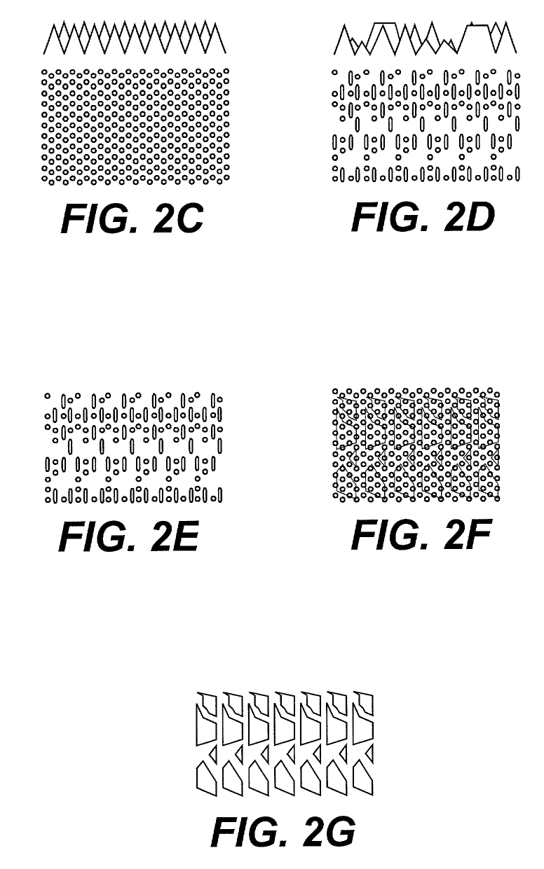

FIG. 2A is a side view of the patterned printer roller 200 having a patterned surface 202. FIG. 2B is a cross-sectional view of the patterned printer roller 200 taken on line 2B-2B in FIG. 2A. A patterned surface 202 of the patterned printer roller 200 creates an identifiable texturing on the print medium 110, which can be used to match the print medium 110 with the printer system 100. The patterning of the patterned surface 202 is exaggerated in FIG. 2B for illustrative purposes.

The patterned printer roller 200 may comprise several components, including a cylindrically shaped core 205 wrapped by an outer layer 210 that conforms to the cylindrical shape of the core 205. A metal collar 212 may be affixed to the ends of the patterned printer roller 200 to allow the patterned printer roller 200 to be attached to a shaft (not shown) that is rotated by a motor (not shown) in the printer system 100. Alternatively, the shaft may be formed as a part of the patterned printer roller 200. The other printer rollers 105 are also designed to be rotated on shafts by a motor in the printer system 100. The outer layer 210 is patterned so that the print medium 110 is imprinted by the patterned surface 202 when the print medium 110 passes through a printer roller pair 130 including the patterned printer roller 200. The core 205 and the outer layer 210 may be made of the same or different materials. The core 205 is preferably made of a rigid material. The outer layer 210 is preferably made of a high friction material, such as an elastomer or other similar material that enables gripping of various kinds of print media. Alternatively, the patterned printer roller 200 may comprise a single component made of, for example, synthetic rubber. In this embodiment, the outer surface of the patterned printer roller 200 is patterned. The other printer rollers 105 in the printer system 100 may be similar in construction to the patterned printer roller 200, except that an outer layer 210 with a patterned surface 202 is not required.

The print medium 110 is inserted into the printer system 100 at the entry 115. The printer rollers 105 grip the print medium 110 at the entry 115 and pull the print medium 110 into the printer system 100. The print medium 110 is then advanced through the printer system 100 by the printer rollers 105 along the paper feed path 120. The print medium 110 undergoes a print process and is imprinted with an identifiable texturing by the patterned surface 202. The motor in the printer system 100 rotates the patterned printer roller 200 about a longitudinal axis 215. The printer rollers 105 in each printer roller pair 130 may also be rotated by motors. The print medium 110 is then ejected at an exit 125.

In FIG. 1, the printer system 100 includes one patterned printer roller 200. However, opposed patterned printer rollers 200 may be included in a printer roller pair 130 so that identifiable texturing is imprinted on both sides of the print medium 110. The patterned printer rollers 200 may grip the print medium 110 at opposite sides or in multiple places across the entire width of the print medium 110, thereby imprinting identifiable texturing on opposite sides or at multiple places across the entire width of the print medium 110, respectively.

The identifiable texturing imprinted on the print medium 110 may be detected using one of several inspection methods. Once the texturing has been identified, the texturing may be matched with the printer system 100 having the patterned printer roller 200 that matches the texturing on the print medium 110. Various methods for identifying texturing on print media may be used. In one example, the texturing imprinted by the patterned printer roller 200 may be detected using a stylus or optical surface roughness profilometer, such as is used in semiconductor wafer processing industries. When using a stylus profilometer, a stylus is moved along the surface of a textured print medium and the vertical motions of the stylus are measured and plotted to generate a topographic map. There are many other surface profiling techniques that may be used. In another example, a glancing incident photo reflection system may be used. In a glancing incident photo reflection system, light is projected onto a textured print medium at near glancing incident angles from a single direction, casting shadows in depressions that can be detected with a microscope and/or recorded with another light measuring device. Scanning the textured print medium and changing the direction of the light allows the pattern on the surface of the print medium to be topographically mapped.

FIGS. 2C-2G illustrate various patterns for the patterned surface 202 of the patterned printer roller 200. In FIG. 2C, a regular pattern of projections, or “teeth”, of the patterned printer roller 200 would imprint a regular texturing pattern on a print medium. In FIGS. 2D-2F, an irregular pattern of teeth of the patterned printer roller 200 imprints an irregular texturing pattern on a print medium. Additionally, the irregular pattern may include different shapes, including shapes that resemble a jigsaw puzzle.

Referring to FIG. 2G, an irregular pattern of teeth of the patterned printer roller 200 may be used together with invisible ink or chemical tracers dispensed throughout the surface of the patterned printer roller 200.

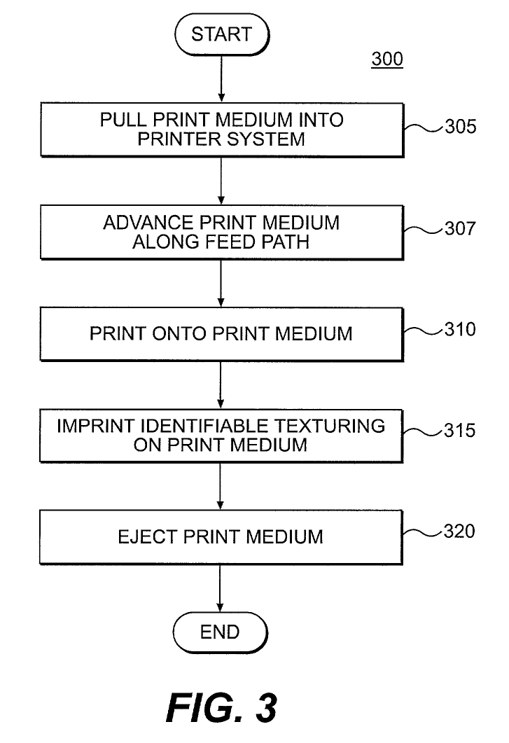

The pattern formed on the outer layer 210 may be predetermined, including, for example, an identifiable repetitive pattern, or random, including, for example, an identifiable arbitrary pattern. Alternatively, the patterned surface 202 may include both predetermined and random pattern elements. A predetermined or random pattern of identifiable texturing may therefore be imprinted on the print medium 110. A method for imprinting the print medium 110 is discussed below with reference to FIG. 3. The method is appropriate for imprinting both random and predetermined texturing on the print medium 110.

FIG. 3 is a flow chart 300 illustrating a method for imprinting an identifiable texturing on the print medium 110 using a printer system 100 having a patterned printer roller 200. In step 305, the print medium 110 is pulled into the printer system 100. In step 307, the print medium is advanced along the feed path 120. In step 310, the print medium 110 is printed upon by toner system 122 in the printer system 100. In steps 305-310, the print medium 110 undergoes a print process that is commonly used, for example, in ink jet or laser printer systems.

In step 315, the print medium 110 is gripped by the patterned printer roller 200 and moved tangentially and in contact with the patterned outer layer 210 of the patterned printer roller 200. The patterned outer layer 210 imprints identifiable texturing on the face of the print medium 110 that is in contact with the patterned outer layer 210. The identifiable texturing imprinted on the print medium 110 corresponds to the patterned surface 202.

In step 320, the print medium 110 is ejected from the printer system 100 at the exit 125. As an alternative to the above method, the print medium 110 may be imprinted with identifiable texturing before being printed upon.

The printer system 100 may also include a printer roller pair 130 comprising two opposed patterned printer rollers 200. In this case, in step 315, the opposed patterned printer rollers 200 grip the print medium 110 simultaneously on both faces of the print medium 110, and imprint identifiable texturing on both faces of the print medium 110.

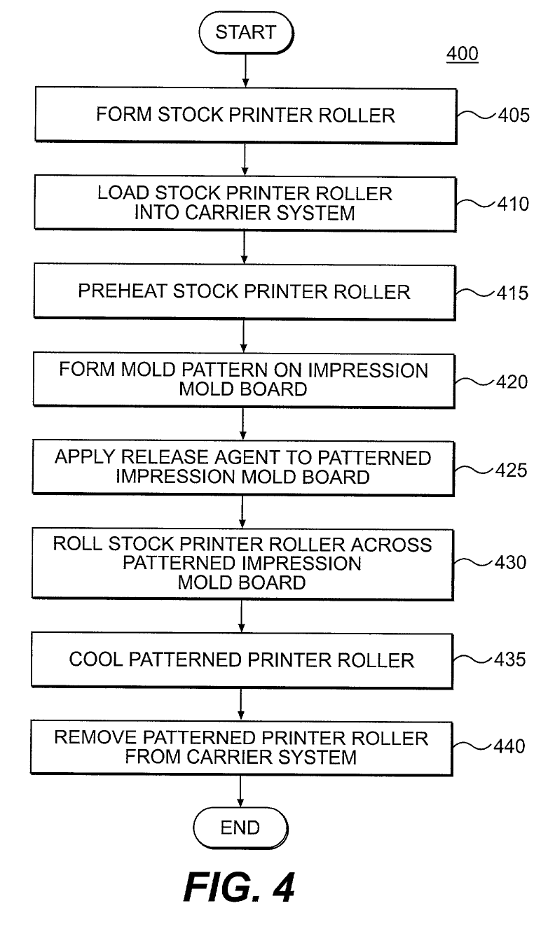

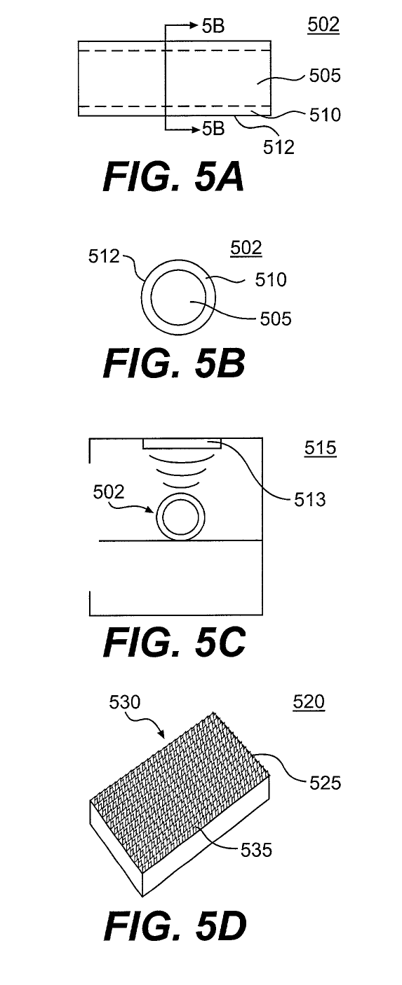

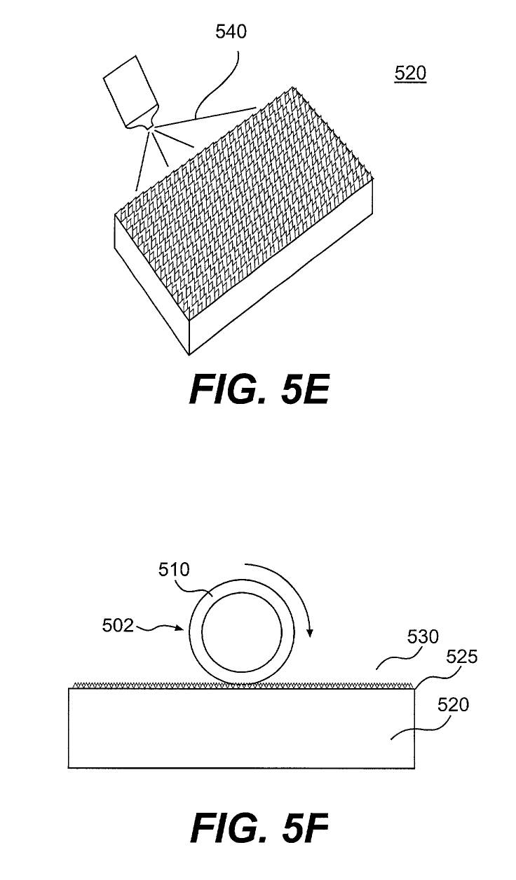

FIG. 4 is a flow chart 400 illustrating a method for making the patterned printer roller 200. FIGS. 5A-5F illustrate the printer roller 200 at various states in the method. In this embodiment, the patterned surface 202 is formed by an impression mold process. A multi-component patterned printer roller 200 is discussed in the following description. However, the patterned printer roller 200 may be made of a single component or several components.

Referring to FIGS. 5A and 5B, in step 405, a stock printer roller 502 having a core 505 and outer layer 510 is formed. FIG. 5B is a cross-sectional view taken on line 5B-5B in FIG. 5A. The external surface 512 of the outer layer 510 of the stock printer roller 502 is preferably smooth, with minimal indentations or impressions. As described above, the core 505 may be made of, for example, elastomer, and the outer layer 510 may be made of, for example, rubber. The core 505 and outer layer 510 of the stock printer roller 502 may be manufactured through various known processes such as, for example, injection molding or extrusion. The core 505 and outer layer 510 may be combined, for example, using an adhesive bonding process.

Referring to FIG. 5C, in step 410, the stock printer roller 502 is loaded into a carrier system 515 that guides and supports the stock printer roller 502 during the impression mold process. In step 415, the stock printer roller 502 is preheated to a temperature that sufficiently softens the outer layer 510 so that indentations and/or projections can be formed into the outer layer 510. The projections may resemble miniature teeth. The stock printer roller 502 may be heated by an external heat source 513, or alternatively, heated from within the stock printer roller 502 by various known methods. Additionally, an impression mold board, described in detail below, may be heated before the impression mold board is put in contact with the stock printer roller 502.

FIG. 5D illustrates an impression mold board 520 used to form the pattern in the outer layer 510. The impression mold board 520 has a surface 525 that is initially smooth having minimal indentations and/or projections. In step 420, a mold pattern 530 is formed on the surface 525 of the impression mold board 520. The impression mold board 520 may be formed of, for example, a metallic material. The mold pattern 530 may be formed, for example, by etching or impressing a pattern into the surface 525, resulting in a mold pattern 530 of small indentations and/or projections 535 formed on the surface 525. Impressing the mold pattern 530 may be performed by mechanical means, for example. Etching may be, for example, laser or chemical etching and may be performed by a computerized system. The mold pattern 530 is exaggerated in FIGS. 5D and 5E for illustrative purposes. The indentations and/or projections 535 may be of various sizes and shapes in order to produce a wide variety of mold patterns 530.

The mold pattern 530 may be predetermined or random. For a predetermined pattern, the etching process may be a computer-controlled process that produces the indentations and/or projections 535 on the surface 525 of the impression mold board 520. The indentations and/or projections 535 may be etched into an identifiable repetitive pattern. For a random pattern, the etching process may be a computer-controlled process that incorporates a random number generator. The random number generator produces an identifiable arbitrary pattern of indentations and/or projections 535 on the surface 525 of the impression mold board 520.

Etching the indentations and/or projections 535 into the surface 525 of the impression mold board 520 results in a patterned impression mold board 520. Referring to FIGS. 5E and 5F, in step 425, a release agent 540 is applied to the patterned impression mold board 520. The release agent 540 helps to reduce excessive adhesion between the outer layer 510 of the stock printer roller 502 and the mold pattern 530 as the stock printer roller 502 is rolled across the patterned impression mold board 520.

In step 430, the stock printer roller 502 is rolled across the impression mold board 520, and the mold pattern 530 formed on the surface 525 impresses the outer layer 510 of the stock printer roller 502. The outer layer 510 is impressed with a pattern corresponding to the mold pattern 530 and the stock printer roller 502 is formed into a patterned printer roller 200.

In step 435, the patterned printer roller 200 is cooled in order to fix the pattern on the outer layer 510. In step 440, the patterned printer roller 200 is removed from the carrier system 515.

One advantage of the above embodiment is that the patterned printer roller 200 may be formed to have a patterned surface that imprints identifiable texturing on a print medium that is not detectable to the unaided eye. This may be accomplished by using an etching process having a high resolution to create a very fine mold pattern 530 on the surface 525 of the impression mold board 520. The high resolution pattern on the surface 525 therefore impresses a fine pattern on the surface of the stock printer roller 502, so that the patterned printer roller 200 imprints a fine, identifiable texturing on print media. The identifiable texturing may be detected using various known inspection systems, such as a surface roughness profiler or a glancing incident photo reflection system as described above.

Another advantage is that the patterned printer roller 200 may be formed to have a patterned surface that imprints identifiable texturing that is unique. For example, each mold pattern 530 may consist of a unique configuration of indentations and/or projections 535. Therefore, each patterned printer roller 200 may have a unique patterned surface 202 that imprints unique texturing. Unique texturing ensures that the print medium 110 can be accurately matched to the printer system that produced the print medium 110.

As an alternative to the impression mold process described in FIG. 4, the patterned printer roller 200 may be formed by a direct etching process of the outer layer of a stock printer roller. The etching process may be a computer-controlled process that produces a pattern of indentations and/or projections directly on the surface of the outer layer.

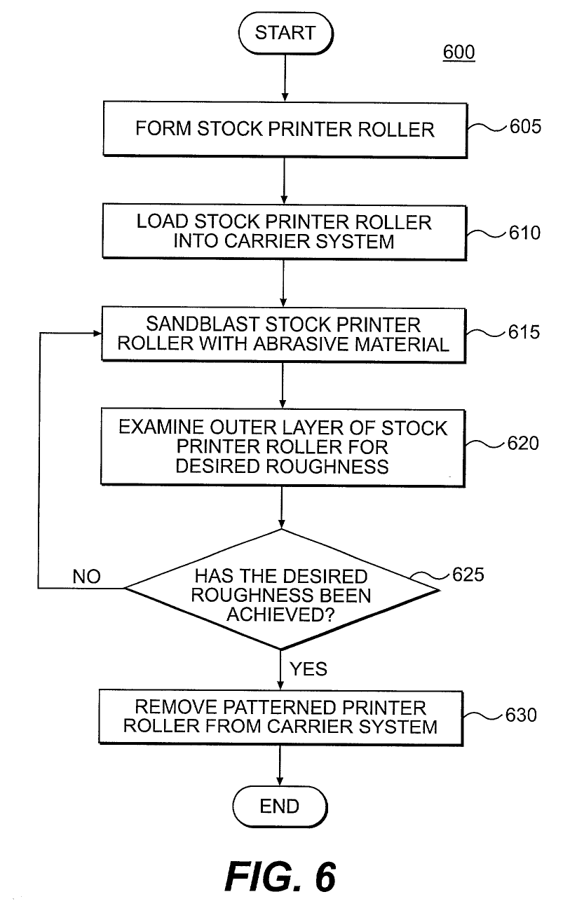

FIG. 6 is a flow chart 600 illustrating an alternative method for making the patterned printer roller 200. In this embodiment, the patterned outer layer 210 is formed by a sandblasting process. A multi-component patterned printer roller 200 is discussed in the following description. However, the patterned printer roller 200 may be made of a single component or several components.

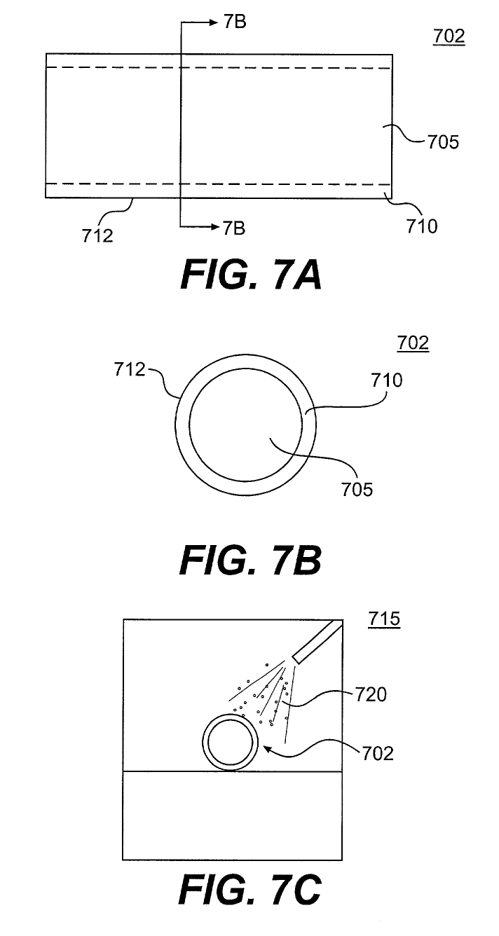

Referring to FIGS. 7A and 7B, in step 605, a stock printer roller 702 having a core 705 and outer layer 710 is formed. The core 705 and the outer layer 710 of the stock printer roller 702 may be manufactured through various known processes as described above. The stock printer roller 702 is manufactured so that the external surface 712 of the outer layer 710 is preferably smooth, containing minimal indentations or impressions.

Referring to FIG. 7C, in step 610, the stock printer roller 702 is loaded into a carrier system 715 that guides and supports the stock printer roller 702 during the sandblasting process. In step 615, the outer layer 710 of the stock printer roller 702 is initially sandblasted with an abrasive material 720 to form a random pattern on the outer layer 710. The abrasive material 720 may comprise particles of various sizes and shapes.

After the initial sandblasting step 615, the outer layer 710 is examined in step 620 to determine whether a desired roughness has been achieved. The desired roughness may be a roughness sufficient for forming a patterned surface on the outer layer 710 that is capable of imprinting an identifiable texturing on the print medium 110 that is preferably not detectable to the unaided eye. In step 625, if the desired roughness has not been achieved by the initial sandblasting step 615, further sandblasting is performed on the outer layer 710 until the desired roughness is achieved. A patterned printer roller 200 results from step 625. The patterned printer roller 200 is removed from the carrier system 715 in step 630.

Due to the inherent random nature of the sandblasting process, the patterned surface formed on the outer layer 710 is statistically ensured to be unique. Therefore, each patterned printer roller 200 having a patterned surface 202 formed by the sandblasting process will imprint unique texturing on the print medium 110. The random pattern on the patterned surface 202 can include indentations caused by the impact of the abrasive material on the stock printer roller 702.

Other methods that may be used to form a random pattern on the outer layer 710 of the stock printer roller 702 include laser ablation of the surface of the stock printer roller, impinging the surface of the stock printer roller with a water jet, etching the surface of the stock printer roller with acid and sputtering the surface of the stock printer roller.

While the printer system has been described in connection with an exemplary embodiment, it will be understood that many modifications will be readily apparent to those skilled in the art, and this application is intended to cover any variations thereof.

What is claimed is:

1. A printer roller for use in a printer system comprising:
a roller having a surface with a predetermined pattern of at least one of indentations and projections formed therein.

2. The printer roller of claim 1, where the predetermined pattern is an identifiable repetitive pattern.

3. A printer roller for use in a printer system comprising:
a roller having a surface with a random pattern of at least one of indentations and projections formed therein.

4. The printer roller of claim 3, where the random pattern is an identifiable arbitrary pattern.

5. A method for making a printer roller having a patterned surface, comprising:
forming a predetermined pattern on a surface of a stock printer roller, the predetermined pattern being capable of imprinting an identifiable texturing on a print medium.

6. The method of claim 5, where the predetermined pattern is an identifiable repetitive pattern.

7. The method of claim 5, where the step of forming comprises:
impressing the surface of the stock printer roller with a mold having a patterned surface.

8. The method of claim 7, further comprising:
heating the stock printer roller before the step of impressing.

9. The method of claim 5, where the step of forming comprises:
etching the surface of the stock printer roller.

10. The method of claim 9, where the etching step comprises laser etching.

11. The method of claim 9, where the etching step comprises chemical etching.

12. A method for making a printer roller having a patterned surface, comprising:
forming a random pattern on a surface of a stock printer roller, the random pattern being capable of imprinting an identifiable texturing on a print medium.

13. The method of claim 12, where the random pattern is an identifiable arbitrary pattern.

14. The method of claim 12, where the step of forming comprises:
sandblasting the surface of the stock printer roller.

15. The method of claim 12, where the step of forming comprises:
ablating the surface of the stock printer roller with a laser.

16. The method of claim 12, where the step of forming comprises:
impinging the surface of the stock printer roller with a water jet.

17. The method of claim 12, where the step of forming comprises:
etching the surface of the stock printer roller with an acid.

18. The method of claim 12, where the step of forming comprises:
sputtering the surface of the stock printer roller.

19. A method for imprinting identifiable texturing on a print medium, comprising:
advancing the print medium through a printer system having a printer roller with a patterned surface; and
imprinting a predetermined pattern on the print medium.

20. A method for imprinting identifiable texturing on a print medium, comprising:
advancing the print medium through a printer system having a printer roller with a patterned surface; and
imprinting a random pattern on the print medium.

21. A method for identifying texturing on a print medium, comprising:
profiling a textured surface of the print medium; and
generating a topographic map of the textured surface.

22. The method of claim 21, where the step of profiling comprises:
moving a stylus along the textured surface of the print medium;
measuring motions of the stylus; and
plotting the motions of the stylus.

23. A method for identifying texturing on a print medium, comprising:
projecting light onto a textured surface of the print medium, wherein the light is projected at near glancing incident angles from several directions, and wherein the light casts shadows in depressions formed in the textured surface;
detecting a length of the shadows for the directions;
plotting the lengths of the shadows for the directions; and
generating a topographic map of the textured surface.
